(19) United States
(12) Patent Application Publication
(10) Pub. No.: US 2026/0238629 A1
(43) Pub. Date: Aug. 13, 2026

(54) METHOD, DEVICE, AND MEDIUM FOR NETWORK STATE-AWARE TOKENIZED INTERFACE PRIORITIZATION AND AUTHORIZATION SERVICE

(71) Applicant: Verizon Patent and Licensing Inc., Basking Ridge, NJ (US)

(72) Inventors: Peter B. Sensenbrenner, North Richland Hills, TX (US); David Taft, Keller, TX (US); Lap Tse, Marietta, GA (US)

(21) Appl. No.: 19/051,452

(22) Filed: Feb. 12, 2025

(51) Int. Cl. H04L 9/40; H04L 9/32

(52) U.S. Cl. CPC H04L 63/0807; H04L 9/3213

(57) ABSTRACT

A method, a network device, and a non-transitory computer-readable storage medium are described in relation to a network state-aware tokenized interface prioritization and authorization service. The network state-aware tokenized interface prioritization and authorization service may include generating tokens based on information of a network. The tokens may include a priority value for access to a control plane in the network and a security token. The tokens may be issued to external network devices of the network. The tokens may be included in a segment routing extension header of control plane messages from the external network devices. The network may manage access and use of the control plane in the network based on the tokens.

### BACKGROUND

Development and design of networks present certain challenges from a network-side perspective and an end device perspective. For example, utilization of network devices of a core network may present various challenges including minimizing instability, mitigating against congestion, avoiding outages, and the like.

### BRIEF DESCRIPTION OF THE DRAWINGS

FIG. 1 is a diagram illustrating an exemplary environment in which an exemplary embodiment of a network state-aware tokenized interface prioritization and authorization service may be implemented;

FIG. 2 is a diagram illustrating an exemplary embodiment of a token;

FIGS. 3A and 3B are exemplary messaging diagrams illustrating an exemplary process of an exemplary embodiment of the network state-aware tokenized interface prioritization and authorization service;

FIG. 4 is a diagram illustrating exemplary components of a device that may correspond to one or more of the devices illustrated and described herein; and

FIG. 5 is a flow diagram illustrating an exemplary process of an exemplary embodiment of the network state-aware tokenized interface prioritization and authorization service.

### DETAILED DESCRIPTION

The following detailed description refers to the accompanying drawings. The same reference numbers in different drawings may identify the same or similar elements. Also, the following detailed description does not limit the invention.

The use of service-based interfaces (SBIs) between network devices of a core network, such as a Fifth Generation (5G) core network, may introduce non-deterministic transit times between the network devices. Additionally, the incremental inundation of application programming interface (API) calls to a particular network device may subject the network device to potential overutilization and congestion, which may lead to instability of the network device. This instability may have a cascading effect which may ultimately cause other network devices to become unstable and potentially lead to a network outage, in whole or in part.

Efforts to mitigate these problems may include use of an intermediary network device, such as a Service Communication Proxy (SCP), for example. However, the SCP may still yield less deterministic transit times than desired. Additionally, the instability of some network device types, such as a policy control function (PCF), may be more prone to cause a rippling or cascading effect in the (entire) core network. According to other examples, numerous inbound API requests may have the effect of a Distributed Denial-of-Service (DDoS)-like attack that may cause instability at a network device and potentially cause a cascading effect to other network devices or the entire core network. According to still other examples, sets of network devices and high availability frameworks may cause instabilities. As an example, assume that there is a high availability deployment of a PCF amongst a network device set. When a network device (e.g., an access and mobility management function (AMF)) is unable to reach or communicate with another network device (e.g., a PCF_1), the network device (e.g., the AMF) may attempt to reach yet another network device (e.g., a PCF_2) of the network device set. As a consequence, this circumstance may lead to instability and may further exacerbate transit times. According to still other examples, the high volume of API calls may originate from third party network devices which reside outside the core network. For example, third party servers via a network exposure function (NEF) may transmit a high volume of API call requests that can lead to instability of one or more network devices in the core network, a network outage, and/or the like.

According to exemplary embodiments, a network state-aware tokenized interface prioritization and authorization service is provided. According to an exemplary embodiment, the network state-aware tokenized interface prioritization and authorization service may generate tokens. According to an exemplary embodiment, the tokens afford prioritization and authorization pertaining to access and use of control plane messaging in a network by external network devices and/or third party network devices (“external/third party network devices”) relative to the network and/or an entity associated with the network (e.g., a network operator or the like), as described herein. For example, the tokens may enable external/third party network devices to communicate requests (e.g., API requests, Hypertext Transfer Protocol/2 (HTTP/2) requests, or another type of network request) to network devices of the network. According to an exemplary embodiment, the network may be implemented as a 5G core network or a future generation core network.

According to an exemplary embodiment, the network state-aware tokenized interface prioritization and authorization service may generate tokens based on various criteria, as described herein. For example, the criteria may include network topology information, network state information, performance metric information, congestion level information, flow control information, and other information, or a sub-combination thereof, as described herein. According to an exemplary embodiment, the network state-aware tokenized interface prioritization and authorization service may manage the disbursement of the tokens to external/third party network devices.

According to an exemplary embodiment, the network state-aware tokenized interface prioritization and authorization service may provide that the external/third party network devices include the token for control plane messages in a Segment Routing Header (SRH), as described herein. For example, the token may be included in a Type Length Value (TLV) of the SRH. According to an exemplary embodiment, the token may include an interface priority value, as described herein. According to an exemplary embodiment, the token may include security information, as described herein.

In view of the foregoing, the network state-aware tokenized interface prioritization and authorization service may mitigate or prevent instability, overutilization, congestion, and outages in a network and the network devices thereof due to access and use of control plane messaging associated with external/third party network devices. The network state-aware tokenized interface prioritization and authorization service may manage non-deterministic transit times of control plane messaging based on the criteria-based generation and issuance of tokens, as described herein.

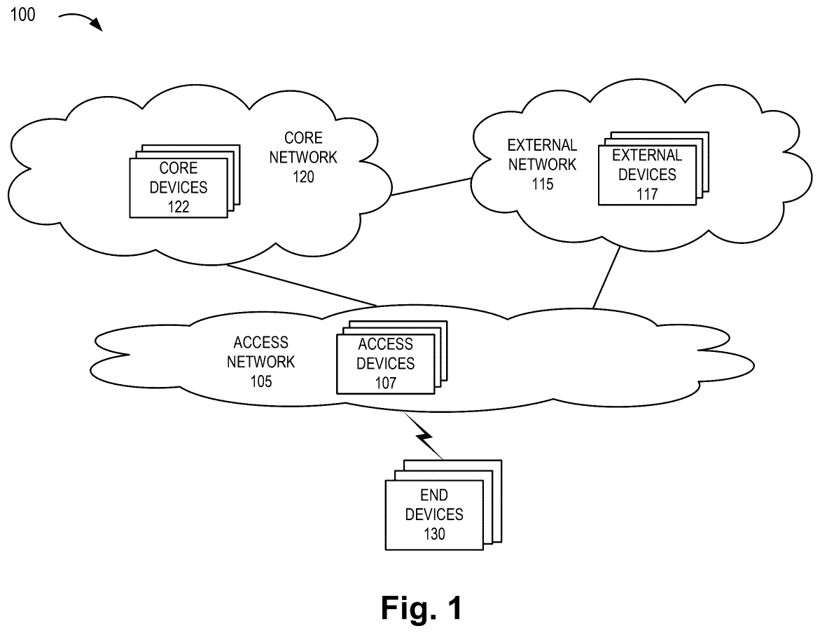

FIG. 1 is a diagram illustrating an exemplary environment 100 in which an exemplary embodiment of network state-aware tokenized interface prioritization and authorization service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), an optical network, a wired network, etc.), a time-sensitive network (TSN) system, a deterministic networking (DetNet) network, or another type of network that may support a wireless service and/or an application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, quality of service (QoS) flows, packet data unit (PDU) sessions, channels, network paths, tunnels, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, a network management plane, an artificial intelligence and/or a machine learning (AI/ML) (control) plane, and a future generation plane, or a subset thereof. Environment 100 may include other types of planes of communication. A message communicated in support of the network state-aware tokenized interface prioritization and authorization service may use and/or pertain to at least one of these planes. For example, the message of an exemplary embodiment of network state-aware tokenized interface prioritization and authorization service may use and pertain to the control plane. According to various exemplary implementations, the interface of the network device may be an SBI, a reference point-based interface, an Open Radio Access Network (O-RAN) interface, a 5G interface, another generation of interface (e.g., 5G Advanced, Sixth Generation (6G), Seventh Generation (7G), Fourth Generation (4G), etc.), or some other type of network interface (e.g., proprietary, etc.).

Access network 105 may include one or multiple networks of one or multiple types and technologies. For example, access network 105 may be implemented to include a terrestrial network, a non-terrestrial network (e.g., a satellite network, an air-based network, etc.), or a combination thereof. By way of further example, access network 105 may include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced, LTE Advanced Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., non-standalone (NSA) NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), or another type of cellular wireless station. Access devices 107 may also include a network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IP Multimedia System (IMS) network, a Rich Communication Service (RCS) network, a software defined (SD) network, a virtual network, a packet-switched network, a data center, or other type of network that may provide access to and may host an end device application service or a network application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions, as described herein. External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., ultra-low-cost network, etc.), enhanced mobile broadband (eMBB), higher user mobility (e.g., high speed train, remote computing, moving hot spots, etc.), Internet of Things (IoT) services (e.g., smart wearables, sensors, mobile video surveillance, smart cities, connected home, massive IoT (mIoT), critical IoT (cIoT), etc.), extreme real-time communications (e.g., tactile Internet, augmented reality (AR), virtual reality (VR), eXtended reality (XR), mixed reality (MR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, gaming (e.g., cloud gaming (CG), etc.), and/or other types of wireless and/or wired application services.

External devices 117 may also include other types of network devices that support the operation of external network 115 and/or the provisioning of application services, such as an orchestrator, an edge manager, an operations support system (OSS), a local domain name system (DNS), registries, a gateway, and/or external devices 117 that may pertain to various network-related functions or services (e.g., security, management, charging, billing, authentication, authorization, policy enforcement, development, communication with other networks, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an EPC of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an AMF, a session management function (SMF), a unified data management (UDM) device, a unified data repository (UDR), an authentication server function (AUSF), a network slice selection function (NSSF), a network repository function (NRF), a PCF, a network data analytics function (NWDAF), a network exposure function (NEF), an SCP, a Time Sensitive Communication and Time Sensitive Function (TSCTCF), a future generation core device (e.g., a 5G-Advanced core device, a 6G core device, a 7G core device, etc.), a service capability exposure function (SCEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and a charging system (CS), or a sub-combination thereof. Additionally, core devices 122 may include transport devices (e.g., routers or the like), and a transport control device, such as a path computation engine (PCE).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5G Advanced, 5G and 6G, etc.), such as an SMF with PGW control plane functionality (e.g., SMF+PGW-C), a UPF with PGW user plane functionality (e.g., UPF+PGW-U), and/or other types of combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 include logic of an exemplary embodiment of the network state-aware tokenized interface prioritization and authorization service, as described herein.

According to an exemplary embodiment, an AF or a future generation AF (referred to herein as an AF) may include logic of an exemplary embodiment of the network state-aware tokenized interface prioritization and authorization service, as described herein. According to an exemplary embodiment, the AF may dynamically generate and issue tokens based on various criteria, as described herein.

According to an exemplary embodiment, the criteria may include information pertaining to historical, current, and/or prospective network state information of core network 120 (e.g., in its entirety) and/or a portion of core network 120 (e.g., one or multiple core devices 122 but not all core devices 122). For example, the network state information may include parameters and values relating to loads associated with core devices 122. By way of further example, the parameters and values may relate to network resources, such as hardware (e.g., processor, memory, storage, network interface, buffer, bus, etc.), software (e.g., a network device application, an operating system (OS), etc.), a virtual or a logical component (e.g., a container, a virtual machine (VM), a pod, etc.), and the like, and their associated states, such as amount available or unused, amount used, amount of reserve above a nominal capacity, or the like. According to an exemplary embodiment, the network state information may include parameters and values relating to loads associated with communication links (e.g., wired, optical, etc.) between core devices 122. A parameter value may be implemented as a single value (e.g., X) or a range of values (e.g., X to Y). The parameter value may also be associated with a time period (e.g., seconds, hour(s), day(s), and/or another time period). The parameter value may indicate an average value, a mean value, and/or another statistical value.

According to an exemplary embodiment, the criteria may further include network topology information and network device set information, as described herein. For example, the network topology information may include information relating to the number, type, and arrangement of core devices 122 and communication links between core devices 122, as described herein. The network device set information may include information indicating sets of core devices 122 associated with high availability (HA) and redundancy frameworks, as described herein.

According to an exemplary embodiment, the AF may obtain network state information, such as load information, network topology information, and network device set information from an NRF. For example, the NRF may obtain and store network state information from all registered core devices 122. Additionally for example, the NRF may obtain and store network topology and network device set information from a network management device and/or another core device 122 that may provide real-time or substantially real-time status of such information. The AF may obtain the network state information, network topology information, and network device set information, in whole or in part, from the NRF via a push or pull communication method. According to other exemplary embodiments, the AF may obtain network state information, network topology information, and network device set information, in whole or in part, from another centralized or distributed network device source (e.g., one or multiple network devices other than the NRF).

According to an exemplary embodiment, the criteria may include performance metric information. For example, Two-Way Active Measurement Protocol (TWAMP) network devices or agents may measure and provide to the AF, directly or indirectly (e.g., via an intermediary network device), transit times and other metrics relating to control plane messaging between core devices 122. For example, the TWAMP network devices or agents may provide two-way or round-trip measurements based on timestamps. The performance metrics may also include jitter and packet loss, for example.

According to an exemplary embodiment, the criteria may include flow control and congestion level information. For example, an SCP may provide flow control information, which may include ingress/egress rate limiting information, to the AF, as described herein. The SCP may provide congestion information relating to communication links, segment routing, network path or portion thereof, between core devices 122 and between the SCP and core devices 122, as described herein. According to other exemplary embodiments, the flow control information and/or the congestion level information may be provided by core devices 122, in whole or in part, depending on the configuration of the SCP relative to other core devices. For example, the SCP may function as an intermediary network device for some but not all core devices 122. The SCP may provide other types of metric information, such as throughput, bitrates, packet error rate, packet drop rate, and the like.

According to an exemplary embodiment, the criteria may also include transport information. For example, a PCE may provide the transport information to the AF, as described herein. The transport information may include information regarding network path routes between core devices 122, between the SCP and core device 122, between network device sets, segment routers, and the like, and their associated network path states (e.g., up, down, etc.), current routing and rerouting information, and the like.

According to an exemplary embodiment, the criteria may include token management information. For example, the token management information may include values pertaining to how many tokens have been issued over a period of time (e.g., a rate of token issuance), how many tokens are being used over a period of time (e.g., a rate of token usage), how many tokens are being requested over a period of time (e.g., a rate of token requests), how many tokens are being generated over a period of time (e.g., rate of token generation), and/or other values relating to the issuance, usage, generation, and the like of the tokens.

According to an exemplary embodiment, the AF may include logic that assists in the current or prospective deployment of AFs in core network 120. For example, the AF may communicate to an orchestration system or similar network management system, which may serve as a trigger to spawn or instantiate a new AF (e.g., horizontal scaling) or alternatively modify the current vertical scaling (e.g., modifying an amount of resources allocated to the AF) of the AF. The AF may determine whether to transmit the request based on the token management information. Additionally, the AF may also analyze scaling policies or rules relating to how long horizontal scaling or vertical scaling may take to perform. In this way, the AF may transmit the request in sufficient time so that network demand for servicing network requests with tokens may be supported.

According to an exemplary embodiment, the network state-aware tokenized interface prioritization and authorization service may prioritize access and use of control plane messaging to core devices 122 over access and use of control plane messaging by external/third party network devices 117.

According to an exemplary embodiment, a NEF, a future generation exposure function (EF), an SCEF, or another type of network device that may provide similar functions or services as the NEF (referred to herein as a NEF) may include logic of an exemplary embodiment of the network state-aware tokenized interface prioritization and authorization service, as described herein. According to an exemplary embodiment, the NEF may only service network requests from external/third party network devices 117 when the network requests include tokens that are valid.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, etc.), a computer (e.g., laptop, palmtop, etc.), a gaming device, a music device, an IoT device, a drone, a smart device, a television, a set top box, a media player or streaming device, a telematics device, or another type of wireless device (e.g., another type of UE). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

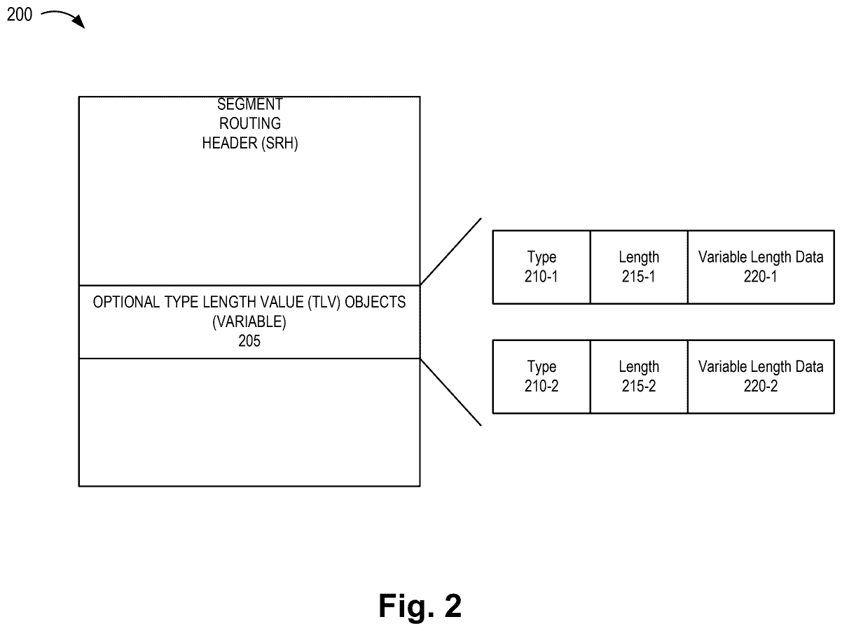

FIG. 2 is a diagram illustrating an exemplary embodiment of a token, as described herein. According to an exemplary embodiment the token of the network state-aware tokenized interface prioritization and authorization service may be implemented in an SRH. For example, as illustrated an SRH 200 may include a TLV 205.

Although not illustrated SRH 200 may include various fields, such as Next Header, Header Extension Length, Routing Type, Segments Left, and others, which have been omitted from FIG. 2 and this description for the sake of brevity. According to various exemplary embodiments, SRH 200 may be implemented with fields that are specified according to a network standards entity (e.g., Internet Engineering Task Force (IETF), etc.) or of a proprietary nature. Generally, a TLV provides metadata for segment processing by a network device identified in the destination address of the packet, for example.

According to an exemplary embodiment, SRH 200 may be added to an Internet Protocol version 6 (IPv6) packet. According to other exemplary embodiments, SRH 200 may be added to a future generation IP packet or other suitable packet associated with a layer or protocol of a protocol stack, an Open Systems Interconnection (OSI) model layer, or the like.

TLV 205 may include the token. According to an exemplary embodiment, the token may be included in SRH 200 according to a type, length, variable length data format. As illustrated, according to an exemplary embodiment, the token may include multiple type-length-variable length data instances, such as a type 210-1, a length 215-1, and a variable length data 220-1; and a type 210-2, a length 215-2, and a variable length data 220-2. According to other exemplary embodiments, the token may be implemented with additional, different, or fewer type-length-variable length data instances.

According to an exemplary embodiment, the token may include an interface priority type-length-variable length data instance. The interface priority type-length-variable length data instance may include an indication of a priority associated with network device to network device core control plane messages. For example, type 210-1 may indicate a network device SBI priority or another type of interface priority (e.g., O-RAN interface priority, etc.), as described herein.

According to an exemplary embodiment, the token data may include corresponding length data. For example, length data 215-1 may indicate the length of the variable length data. For example, length data 215-1 may be implemented as 1 byte or 8 bits. According to such an example, the length data 215-1 (e.g., 1 byte) may afford 256 levels of priority in which each level is distinctive. According to other examples, the length data 215-1 may indicate a different length value.

According to an exemplary embodiment, the token data may include corresponding variable length data. For example, variable length data 220-1 may indicate one of the priority values afforded by length data 215-1. For example, a length value of 0 may be afforded the lowest or no priority and a length value of 256 may be afforded the highest priority.

According to an exemplary embodiment, the token may further include a security type-length-variable length data instance. The security type-length-variable length data instance may be used for authorization and/or another type of security measure (e.g., authentication, etc.). For example, type 210-2 may indicate a network device SBI security token. Length data 215-2 may indicate the length of the variable length data. For example, length data 215-2 may be implemented as 256 bits or some other number (e.g., larger or smaller) of bits. Variable length data 220-2 may indicate a value afforded by length data 215-2. The variable length data value may serve as a digital security token.

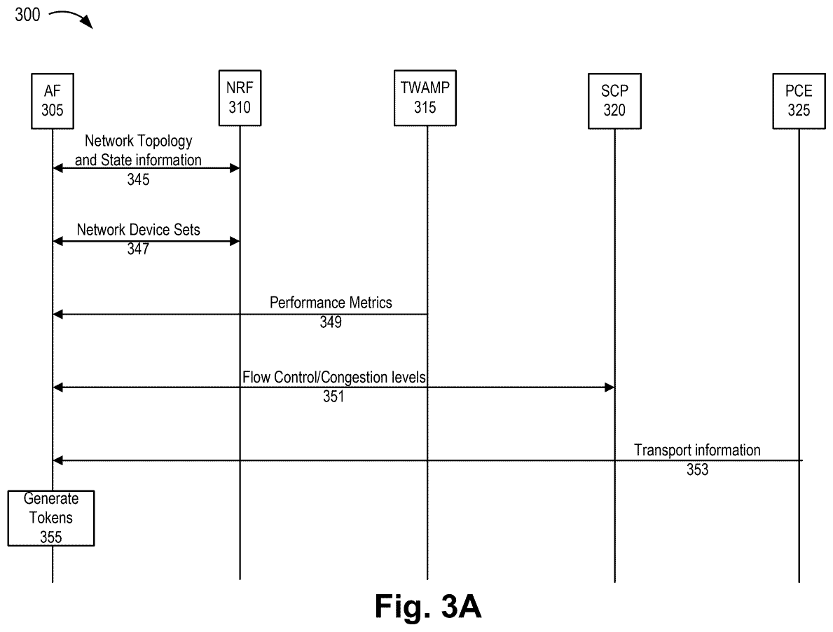

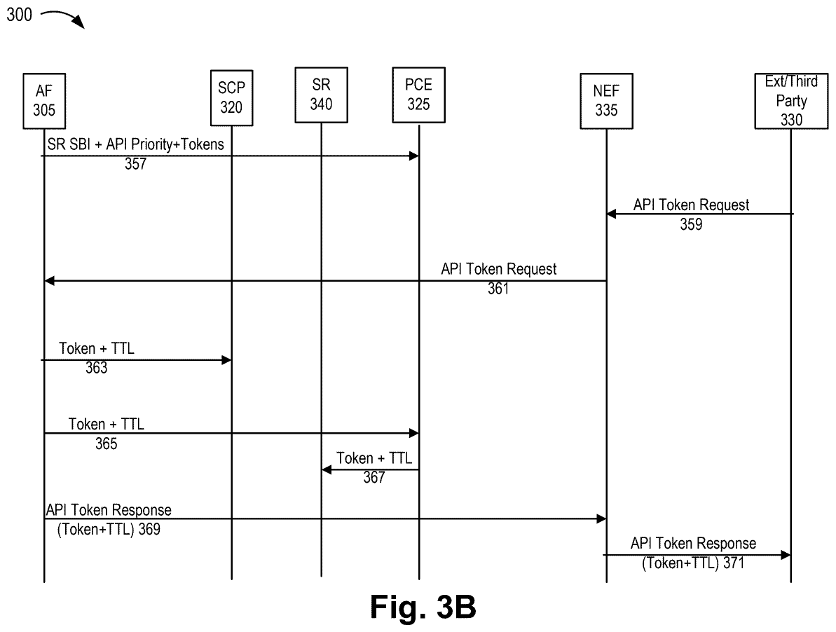

FIGS. 3A and 3B are exemplary messaging diagrams illustrating an exemplary process 300 of an exemplary embodiment of the network state-aware tokenized interface prioritization and authorization service. As illustrated, process 300 may involve exemplary network devices, such as an AF 305, an NRF 310, a TWAMP device 315, an SCP 320, a PCE 325, an external/third party network device 330, a NEF 335, and a segment router (SR) device 340. According to other exemplary embodiments, process 300 may involve fewer, different, or additional network devices. For example, process 300 may be implemented without SCP 320. Additionally, or alternatively, process 300 may be implemented to include an NWDAF or the like.

AF 305, NRF 310, and NEF 335 may each include logic and perform an operation or provide a function that is in accordance with a technical specification associated with a network standardizing body, such as Third Generation Partnership Project (3GPP), 3GPP2, International Telecommunication Union (ITU), European Telecommunications Standards Institute (ETSI), GSM Association (GSMA), or the like. Additionally, AF 305, NRF 310, and NEF 335 may each include logic of the network state-aware tokenized interface prioritization and authorization service, as described herein.

TWAMP device 315 may include a network device that includes TWAMP logic. For example, TWAMP device 315 may include multiple TWAMP agents that report segment transit times and other metrics (e.g., jitter, packet loss, or the like) to AF 305. According to an exemplary embodiment, TWAMP device 315 may report such metrics in relation to a communication plane of core network 120, such as a control plane, as described herein.

SCP 320 may provide Stream Control Transmission Protocol (SCTP) services and multihoming to establish multiple communication paths and addresses (e.g., a primary IP address and one or multiple secondary IP addresses) between network devices, such as core devices 122. SCP 320 may provide active ingress/egress rate limiting information and congestion information to AF 305, as described herein.

PCE 325 may include a network device that calculates and determines network paths, such as network segments and end-to-end communication paths between core devices 122, for messages or traffic of a communication plane, such as a control plane. PCE 325 may include logic that uses metrics provided by TWAMP device 315 and network topology information, to calculate and determine the network paths to route the messages or traffic. According to an exemplary embodiment, PCE 325 may provide AF 305 with transport information associated with network paths, as described herein. According to an exemplary embodiment, AF 305 may provide PCE 325 with token information of TLV 205. According to an exemplary embodiment, PCE 325 may manage the use of tokens by SR device 340, as described herein.

External/third party device 330 may include external device 117. For example, external/third party device 330 may be implemented as a server device that hosts an application service, as described herein. According to other examples, external/third party device 330 may be a network device that supports a network service of external network 115, as described herein.

SR device 340 may include a network device, such as a router or similar type of network device of a transport domain. SR device 340 may include logic that provides segment routing. According to an exemplary embodiment, SR device 340 may route packets based on TLV 205, for example.

Referring to FIG. 3A, process 300 may include AF 305 obtaining network topology and network state information 345 from NRF 310. For example, NRF 310 may store and make available current or real-time status of network topology pertaining to core network 120, in whole or in part. The network topology may relate to core devices 122 and communication links between core devices 122 in relation to physical, virtual, and logical implementations. NRF 310 may also store and make available current or real-time/substantially real-time status of network state information, as described herein. For example, the network state information may pertain to network resources (e.g., hardware, software, etc.) associated with core devices 122, as described herein. Additionally, for example, AF 305 may obtain network device set information 347 from NRF 310. For example, NRF 310 may store and make available current or real-time/substantially real-time status of network sets associated with high availability and redundancy relating to one or more core devices 122 of core network 120, in whole or in part. TWAMP device 315 may also provide performance metrics 349 to AF 305. For example, the performance metrics may include latency, jitter, and packet drop relating to control plane messaging.

SCP 320 may provide flow control information and congestion level information 351 to AF 305. According to an exemplary embodiment, SCP 320 may provide the flow control information and congestion information on a per communication channel basis (e.g., between PCF_1 and AMF_1, etc.) and direction of flow (e.g., from PCF_1 to AMF_1, from AMF_1 to PCF_1, etc.). According to an exemplary embodiment, the flow control information may include ingress and egress rates and rate limiting. For example, the ingress rate information may indicate a current number of transactions or network requests during a period of time (e.g., per second or another time period). According to some exemplary embodiments, SCP 320 may be configured with a threshold value in which SCP 320 may rate limit the number of transactions or network requests. For example, assume that the threshold value for a PCF is 80% or another percentage of the maximum transaction rate for the PCF. When the 80% rate is reached, SCP 320 may begin to rate limit the number of transactions that may exceed the 80% threshold value. In this way, SCP 320 may control and minimize reaching the maximum transaction rate of the PCF. According to this example, SCP 320 may provide flow control information that indicates an adjustment rate for network requests that exceed the 80% rate. Additionally, SCP 320 may provide congestion information to AF 305. For example, the congestion information may include congestion values or levels relating to communication links, network paths, segments, channels, ports, and the like in relation to control plane messaging, such as network requests. The congestion information may include load control information (LCI) and overload control information (OCI), for example.

Process 300 may further include PCE 325 providing transport information 353 to AF 305. For example, the transport information may include information regarding network path routes between core devices 122, between the SCP and core device 122, between network device sets, SRs 340, and the like, and their network path states (e.g., up, down, etc.), current routing and rerouting information, and the like.

Based on receiving the various types of information or a sub-combination thereof, as described herein, AF 305 may determine whether to generate additional tokens. For example, AF 305 may analyze the token management information, as described herein. Additionally, AF 305 may determine whether scaling is needed or not and its type (e.g., vertical versus horizontal) based on token management information, such as current demand, token usage, etc. According to this exemplary scenario, assume AF 305 may determine to generate new tokens 355.

Referring to FIG. 3B, AF 305 may transmit token information 357 to PCE 325. For example, AF 305 may provide an update to PCE 325 regarding current priority levels for network requests and SR SBIs and valid security tokens. PCE 325 may store the token information for management of network paths and SR devices 340.

As further illustrated for process 300, according to an exemplary scenario, external/third party device 330 may transmit a network request, such as an API token request 359 to NEF 335. In response to receiving API token request 357, NEF 335 may forward API token request 359 or generate and transmit an API token request 361, which includes API token request 359, to AF 305. According to an exemplary embodiment, the API token request may include a request for a token, and information relating to a prospective network request. For example, the information may indicate core device 122 (e.g., a PCF, an AMF, etc.) to which the prospective network request pertains, a type of network request (e.g., to establish a PDU session, requesting event or reporting information regarding end device 130, etc.), and/or other information descriptive of the prospective network request and access and use of the control plane of core network 120.

In response to receiving API token request 359 or API token request 361, AF 305 may determine whether to grant or deny the issuance of a token. For example, AF 305 may analyze current network state information (e.g., load, etc.), other network information (e.g., network device set information, etc.), and potentially other information (e.g., policies, rules, business-to-business (B2) information relevant to the requesting external/third party device, other network information). AF 305 may consider other information, such as the type of the network request (e.g., a network request regarding the establishment of a new session, a network request for event information or reporting information, etc.), which may be afforded different priorities, the core device 122 to which the token pertains (e.g., a PCF, an AMF, etc.), etc.

According to this exemplary scenario, AF 305 may determine to grant the token. In response, AF 305 may generate and transmit token information 363 and 365, which pertains to the token to be issued, to SCP 320 and PCE 325, respectively. The token information may include the token or information relating to the token, such as security, priority information, time-to-live (TTL), etc. Additionally, in response to receiving token information 365, PCE 325 may provide token information 367 to SR device 340. In this way, the prospective use of the token will be validated and enable access and use of the control plane according to the permissions provided in the token and the network state-aware tokenized interface prioritization and authorization service, as described herein.

As further illustrated, AF 305 may generate and transmit an API token response 369, which includes the token and TTL information, to NEF 335, which in turn, may forward or provide an API token response 371, to external/third party device 330. In response to receiving API token response 369 or 371, external/third party device 330 may transmit the network request (e.g., API request, HTTP/2 request, etc.), which includes the issued token, via NEF 335 and to core device 122 of relevance.

FIGS. 3A and 3B illustrate an exemplary process 300, however, according to other exemplary embodiments and scenarios, process 300 may include additional operations, fewer operations, and/or different operations. For example, process 300 may further include receiving, by NEF 335, a control plane message, which includes the token, from external/third party device 330. NEF 335 may determine whether the control plane message may be routed to another core device 122 based on the token. For example, NEF 335 may perform a validation procedure based on the information included in the token. When the token is successfully validated, NEF 335 may transmit the control plane message to the appropriate core device 122 (e.g., SCP 320, etc.). The control plane message may be afforded priority and access to the destination core device 122 based on the token. When the token is unsuccessfully validated, NEF 335 may transmit a rejection message to external/third party network device 330.

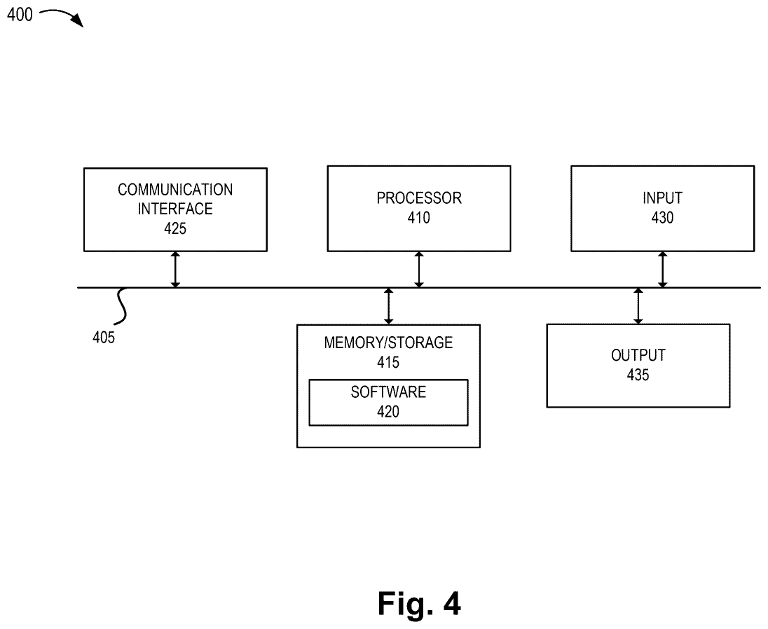

FIG. 4 is a diagram illustrating exemplary components of a device that may correspond to one or more of the devices illustrated and described herein. For example, device 400 may correspond to access device 107, external device 117, core device 122, end device 130, AF 305, NRF 310, TWAMP 315, SCP 320, PCE 325, external/third party device 330, NEF 335, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques and/or technologies including, for example, multithreading, parallel processing, pipelining, interleaving, machine learning, artificial intelligence, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, a solid state drive, mass storage, off-line storage, cloud storage, or some other type of storing medium. Memory/storage 415 may store data, software, and/or instructions related to the operation of device 400.

Software 420 includes an application or a program that provides a function and/or a process. As an example, with reference to AF 305, software 420 may include an application that, when executed by processor 410, provides a function and/or a process of network state-aware tokenized interface prioritization and authorization service, as described herein. Additionally, with reference to NRF 310, SCP 320, PCE 325, and NEF 335, software 420 may include an application that, when executed by processor 410, provides a function and/or a process of the network state-aware tokenized interface prioritization and authorization service or supports the process of the network state-aware tokenized interface prioritization and authorization service, as described herein. Software 420 may also include firmware, middleware, microcode, hardware description language (HDL), and/or other form of instruction. Software 420 may also be virtualized. Software 420 may further include an operating system.

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, spun-up, uninstantiated, deleted, spun-down, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 400 may perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions that are stored by memory/storage 415 cause processor 410 to perform a function or a process described herein. Alternatively, for example, according to other implementations, device 400 performs a function or a process described herein based on the execution of hardware (processor 410, etc.).

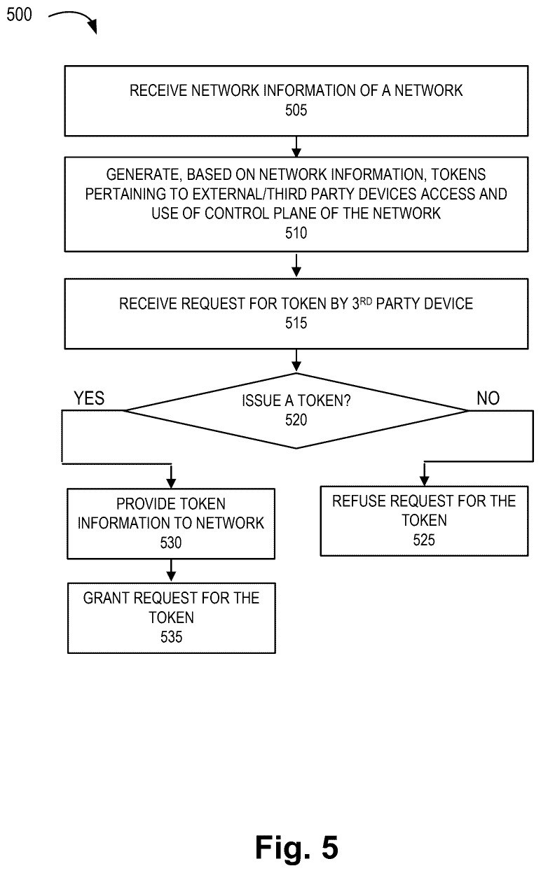

FIG. 5 is a flow diagram illustrating an exemplary process 500 of an exemplary embodiment of the network state-aware tokenized interface prioritization and authorization service. According to an exemplary embodiment, AF 305 may perform a step of process 500. According to an exemplary implementation, processor 410 executes software 420 to perform a step of process 500, as described herein. Alternatively, a step may be performed by execution of only hardware.

In block 505, AF 305 may receive network information of a network. For example, AF 305 of core network 120 may receive distinct types of network information, such as network state information, network topology information, flow control information, congestion level information, and transport information, or a sub-combination thereof, regarding core network 120 or a portion thereof. For example, AF 30 may receive the network information from other core devices 122, such as NRF 310, SCP 320, PCE 325, and core devices 122 subject to the network state-aware tokenized interface prioritization and authorization service (e.g., AMF, SMF, UPF, PCF, UDM, UDR, CHF, etc.), or a sub-combination thereof.

In block 510, AF 305 may generate tokens, which pertains to external/third party network devices access and use of a control plane of the network, based on the network information, as described herein. The tokens may include security token and interface priority information, as described herein. AF 305 may determine whether to generate the tokens based on token management information, as described herein. AF 305 may store the tokens for subsequent issuance to requesting external/third party network devices.

In block 515, AF 305 may receive a request for a token from an external/third party network device. In response, in block 520, AF 305 may determine whether to issue the token or not. For example, AF 305 may analyze one or more types of the network information, information included in the request for the token, and policies or rules relating to the requesting external/third party network device, or a sub-combination of information thereof.

When AF 305 determines to not issue the token (block 520-NO), AF 305 may generate and transmit a response, which indicates a refusal to issue the token, to external/third party network device. For example, AF 305 may refuse the issuance of the token based on congestion levels and/or other types of conditions relating to core network 120, core device 122, or both. In this way, AF 305 may manage and support priority to internal control plane messaging amongst core devices 122 of core network 120.

When AF 305 determines to issue the token (block 520-YES), AF 305 may provide token information to the network (block 530). For example, AF 305 may provide token information regarding a token to SCP 320 and PCE 325 to enable prospective use and validation of the token in a control plane message from the external/third network device, as described herein.

In block 535, AF 305 may generate and transmit a response, which indicates a granting of the issuance of the token, to external/third party network device. For example, the response may include the token.

FIG. 5 illustrates an exemplary process 500 of the network state-aware tokenized interface prioritization and authorization service, according to other exemplary embodiments, the network state-aware tokenized interface prioritization and authorization service may perform additional operations, fewer operations, and/or different operations than those illustrated and described. For example, AF 305 may make determinations regarding auto-scaling in relation to AF 305 and new AFs, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 5, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
receiving, by a network device of a network, information of the network;
generating, by the network device based on the information, tokens, wherein each token includes a priority value for access to a control plane in the network and a security token;
receiving, by the network device from an external network device, a request for a token;
determining, by the network device based on the request, to issue the token; and
transmitting, by the network device to the external network device, the token.

2. The method of claim 1, wherein the information includes network state information associated with network devices of the network and the control plane.

3. The method of claim 1, wherein the information includes transit times associated with network paths of the control plane.

4. The method of claim 1, wherein the information includes at least one of ingress or egress rate limiting information associated with network paths of the control plane.

5. The method of claim 1, further comprising:
generating, by the network device, token management information based on an issuance and a usage of the tokens; and
determining, by the network device based on the token management information and the request, whether to grant or deny the request for the token.

6. The method of claim 1, further comprising:
analyzing, by the network device a current demand for the tokens; and
determining, by the network device, whether a request for auto-scaling is to be transmitted.

7. The method of claim 1, wherein the tokens are configured to be included in a segment routing extension header.

8. The method of claim 1, wherein the network is a Fifth Generation (5G) core network or a 5G Advanced core network.

9. A network device comprising:
a processor that is configured to:
receive information of a network associated with the network device;
generate, based on the information, tokens, wherein each token includes a priority value for access to a control plane in the network and a security token;
receive, from an external network device, a request for a token;
determine, based on the request, to issue the token; and
transmit, to the external network device, the token.

10. The network device of claim 9, wherein the information includes network state information associated with network devices of the network and the control plane.

11. The network device of claim 9, wherein the information includes transit times associated with network paths of the control plane.

12. The network device of claim 9, wherein the information includes at least one of ingress or egress rate limiting information associated with network paths of the control plane.

13. The network device of claim 9, wherein the processor is further configured to:
generate token management information based on an issuance and a usage of the tokens; and
determine, based on the token management information and the request, whether to grant or deny the request for the token.

14. The network device of claim 9, wherein the processor is further configured to:
analyze a current demand for the tokens; and
determine whether a request for auto-scaling is to be transmitted.

15. The network device of claim 9, wherein the tokens are configured to be included in a segment routing extension header.

16. The network device of claim 9, wherein the network is a Fifth Generation (5G) core network or a 5G Advanced core network.

17. A non-transitory computer-readable storage medium storing instructions executable by a processor of a network device, wherein the instructions are configured to:
receive information of a network associated with the network device;
generate, based on the information, tokens, wherein each token includes a priority value for access to a control plane in the network and a security token;
receive, from an external network device, a request for a token;
determine, based on the request, to issue the token; and
transmit, to the external network device, the token.

18. The non-transitory computer-readable storage medium of claim 17, wherein the instructions are further configured to:
generate token management information based on an issuance and a usage of the tokens; and
determine, based on the token management information and the request, whether to grant or deny the request for the token.

19. The non-transitory computer-readable storage medium of claim 17, wherein the information includes at least one of ingress or egress rate limiting information associated with network paths of the control plane.

20. The non-transitory computer-readable storage medium of claim 17, wherein the tokens are configured to be included in a segment routing extension header.
